(19) United States
(12) Patent Application Publication
(10) Pub. No.: US 2014/0355763 A1
(43) Pub. Date: Dec. 4, 2014

(54) METHOD AND APPARATUS FOR GENERATION AND DISTRIBUTING A GROUP KEY IN WIRELESS DOCKING

(71) Applicant: Samsung Electronics Co., Ltd., Gyeonggi-do (KR)

(72) Inventors: Jong-Hyo LEE, Gyeonggi-do (KR); Karthik SRINIVASA GOPALAN, Bangalore (IN); Kiran Bharadwaj VEDULA, Bangalore (IN); Jun-Hyung KIM, Gyeonggi-do (KR)

(21) Appl. No.: 14/295,932

(22) Filed: Jun. 4, 2014

(30) Foreign Application Priority Data
Jun. 4, 2013 (KR) 10-2013-0064070

(51) Int. Cl. H04L 9/08; H04W 12/04; G06F 13/10

(52) U.S. Cl. CPC H04L 9/0819; G06F 13/10; H04W 12/04; H04L 2209/80
USPC 380/282

(57) ABSTRACT

Provided is a communication method using a group key for security of a wireless docking-based service, the communication method including grouping peripheral devices for each wireless docking-based service in association with the peripheral devices and generating a group key that is effective for a time being predetermined for each group and delivering the group key of the group to clients of the group.

### CROSS-REFERENCE TO RELATED APPLICATION(S)

This application claims priority under 35 U.S.C. §119(a) to Korean Patent Application Serial No. 10-2013-0064070, which was filed in the Korean Intellectual Property Office on Jun. 4, 2013, the entire disclosure of which is hereby incorporated by reference.

### TECHNICAL FIELD

Various embodiments of the present disclosure relate to a method and apparatus for using a group key for a service based on wireless docking.

### BACKGROUND

Generally, docking provides connection between an example of a dockee, a rap top, and an external peripheral device to improve user experiences. Such a docking environment is generated mainly in offices where a dockee is docked with a docking center. Herein, the external peripheral device may be, for example, a mouse, a keyboard, a printer, a display, or the like.

The docking may also provide an external connection port function such as a Universal Serial Bus (USB). Recently, with the rise of high-speed wireless connection technologies such as Wimedia or Wireless-Fidelity (Wi-Fi), existing docking based on wired connection is highly likely to be implemented wirelessly. The Wi-Fi docking standard is intended to define a technique for supporting wireless docking. The docking may be implemented in various forms such as an audio dock, an office dock, a vehicle dock, and the like. A Wi-Fi docking mechanism may work based on a Wi-Fi Direct Peer-to-Peer (P2P) protocol that supports direct communication between Wi-Fi-based devices and may also work in an infra connection state. An architecture of Wi-Fi docking includes a Wireless Dockee (WD), a Wireless Docking Center (WDC), and peripheral devices. Herein, the WD receives a docking service, and the WDC is connected with the peripheral devices and is wirelessly connected with the WD to provide a docking service for connection with the peripheral devices. A group including three types of the devices may be defined as a Wireless Docking Network (WDN). Also, a plurality of WDNs may exist in one Wi-Fi Direct P2P group. Each Wi-Fi Direct P2P group includes a Group Owner (GO) that is similar with an Access Point (AP) and group client devices that are similar with a station (STA) device in an infra mode. Herein, the GO is mapped to a channel supporting a particular service, and as a beacon signal is transmitted from the channel, the GO may be discovered by the client devices having received the beacon signal. The client devices having discovered the GO perform a joining procedure for joining a group of the GO. As a part of the group joining procedure, the GO performs a provisioning procedure for delivering a security key to a client. The security key is used for security of communication in the group.

The Wi-Fi Direct standard specifies that a Wi-Fi Protected Access (WPA)2 personal mode has to be necessarily used to maintain safe communication in a P2P group. The WPA2 supports two types of keys, that is, a Pairwise Transient Key (PTK) used for one-to-one communication between the GO/AP and a client and a Group Transient Key (GTK) used for broadcasting or multicasting in the P2P group. The PTK may be generated using a Pairwise Master Key (PMK) generated based on information exchanged previously between the GO and the client. The GTK may be generated from a group master key independently generated in the GO/AP. The PTK is generated using a session-dedicated GO/AP nonce and a client nonce that are exchanged between the GO and the client in a 4-way handshake. The nonce is a session-dedicated random number that is independently generated in a corresponding device and is a one-time number. Herein, the random number means a numeral or character string having randomness. In the 4-way handshake, a Medium Access Control (MAC) address of the GO, a MAC address of the client, a nonce value, and the PMK are used to generate the PTK. The GTK is generated using a Group Master Key (GMK) and a Gnonce that are independently generated in the GO. The GTK is encrypted using the PTK and is delivered to the client through a message #3 of the 4-way handshake. The GTK may be updated through a separate 2-way handshake.

The Wi-Fi docking protocol supports two-hop connection connecting a dockee, a docking center, and a peripheral device. The Wi-Fi docking protocol operates on Wi-Fi Direct P2P connection and uses the WPA2 personal mode security. When the WPA2 personal mode security is used, one-to-one communication is supported using the PTK and multicasting and broadcasting are supported in the group by using the GTK.

A plurality of WDNs may exist in one Wi-Fi Direct P2P group. Respective WDNs, even if belonging to the same Wi-Fi P2P group, form separate groups, such that devices that do not belong to a WDN need to be unable to decrypt communication in the WDN. With a single key, the dockee needs to be able to communicate with devices in every WDN. The docking service is basically based on two hops. Therefore, in the current operation mode, the dockee encrypts data with the PTK of the docking center before transmitting the data to communicate with a peripheral device. Then, the docking center decrypts the data and encrypts the data with the PTK of the peripheral device to deliver the encrypted data to the peripheral device. This process causes a delay, such that a delay-intolerant service such as real-time screen mirroring and screen playback may not be provided smoothly. Such problems may be solved by sharing the PTK of the peripheral device with the dockee, but this solution is not generally used in security and even may bring about a security issue. Hence, a need exists for a method for communication security in a wireless-docking-based WDN.

### SUMMARY

Accordingly, various aspects of the present disclosure provide a method and apparatus for defining a group key for communication security on a WDN basis in a WDN and delivering the group key to peripheral devices.

According to an aspect of the present disclosure, there is provided a communication method using a group key for security of a wireless docking-based service, the communication method including grouping peripheral devices for each wireless docking-based service in association with the peripheral devices and generating a group key that is effective for a time being predetermined for each group and delivering the group key of the group to clients of the group.

According to another aspect of the present disclosure, there is provided a communication method using a group key for security of a wireless docking-based service, the communication method including performing, with a docking center, a procedure for joining a group that supports a first service among wireless docking-based services provided by the docking center and obtaining group key-related information of the group from the docking center.

According to another aspect of the present disclosure, there is provided a docking center that communicates using a group key for security of a wireless docking-based service, the docking center including a controller configured to group peripheral devices for each wireless docking-based service in association with the peripheral devices and to generate a group key that is effective for a time being predetermined for each group, and a transceiver configured to deliver the group key of the group to clients of the group according to an instruction of the controller.

According to another aspect of the present disclosure, there is provided a communication device using a group key for security of a wireless docking-based service, the communication device including a controller configured to perform, with a docking center, a procedure for joining a group that supports a first service among wireless docking-based services provided by the docking center and a transceiver configured to obtain group key-related information of the group from the docking center.

### BRIEF DESCRIPTION OF THE DRAWINGS

FIG. 1 illustrates a general example in which a plurality of WDNs are provided in a docking center (or a Wi-Fi Direct P2P group);

FIG. 2 illustrates an example in which two WDNs exist in one Wi-Fi Direct P2P group and a single WTK is provided for each WDN according to an embodiment of the present disclosure;

FIG. 3 is a flowchart illustrating a process of generating a WTK according to an embodiment of the present disclosure;

FIG. 4 is a flowchart illustrating a process of an in-band distribution scheme using a 2-way WTK handshake message according to an embodiment of the present disclosure;

FIG. 5 is a flowchart illustrating a WTK retransmission operation in a 2-way WTK handshake scheme according to an embodiment of the present disclosure;

FIG. 6 is a ladder diagram illustrating a process of distributing a WTK based on a WTK 2-way handshake in a docking scenario according to an embodiment of the present disclosure;

FIG. 7 is a ladder diagram illustrating operations of an in-band distribution scheme using a KDE procedure of a 4-way handshake according to another embodiment of the present disclosure;

FIG. 8 is a ladder diagram illustrating operations of an in-band distribution scheme using a KDE procedure of a 4-way handshake according to another embodiment of the present disclosure;

FIG. 9 is a block diagram of a WDC according to an embodiment of the present disclosure; and

FIG. 10 is a block diagram of a dockee or a peripheral device according to an embodiment of the present disclosure.

### DETAILED DESCRIPTION

Hereinafter, exemplary embodiments of the present disclosure will be described with reference to the accompanying drawings. It should be noted that the similar components are designated by similar reference numerals although they are illustrated in different drawings. Also, in the following description, a detailed description of known functions and configurations incorporated herein will be omitted when it may obscure the subject matter of the present disclosure. Terms used herein are defined based on functions in the present disclosure and may vary according to users, operators' intention or usual practices. Therefore, the definition of the terms should be made based on contents throughout the specification.

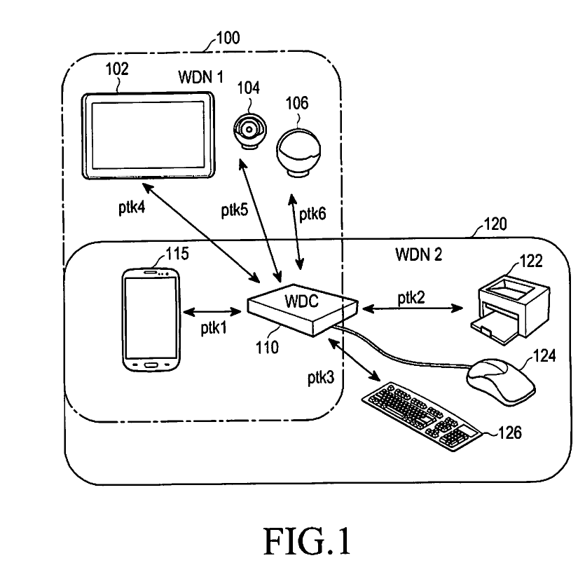

FIG. 1 illustrates a general example in which a plurality of WDNs are provided in a docking center (or a Wi-Fi Direct P2P group).

Referring to FIG. 1, for example, it is assumed that two WDNs exist. First, a WDN1 100 may include peripheral devices connected with a WDC 110, for example, a wireless display 102, a wireless camera 104, and a speaker 106. A WDN2 120 may include peripheral devices connected with the WDC 110, for example, a wireless printer 122, a mouse 124, and a keyboard 126. As an example of a dockee 115 connected with the WDC 110 and thus connected with peripheral devices included in each of the WDN1 100 and the WDN2 120, a smartphone is illustrated. In a general wireless docking technique, the dockee 115 and each of peripheral devices 102-106 and 122-126 are independently connected with the WDC 110, and have their unique PTKs for communication in a corresponding WDN.

To improve a communication security technique in a WDN, an embodiment of the present disclosure proposes a scheme for generating a group key (a WDN Transient Key: a WTK) for communication in the WDN and delivering the group key to a docking center and a peripheral device of the WDN.

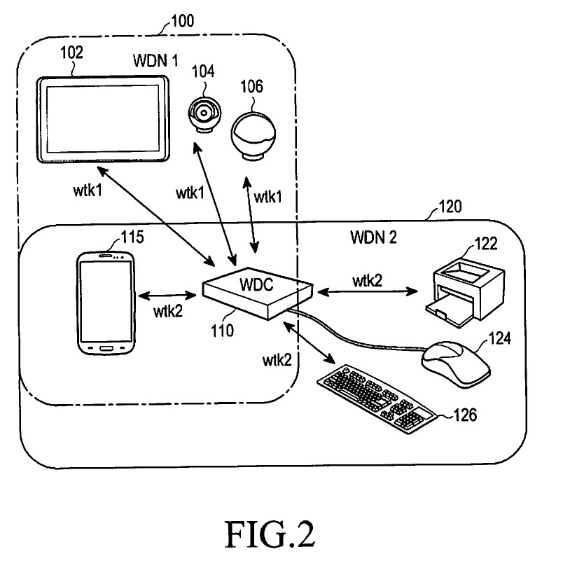

FIG. 2 illustrates an example in which two WDNs exist in one Wi-Fi Direct P2P group and a single WTK is provided for each WDN according to an embodiment of the present disclosure. For convenience, the WDNs of FIG. 2 are assumed to be configured in the same manner as those of FIG. 1.

Referring to FIG. 2, a WTK1 is generated for communication in the WDN1 100. The WTK1 may be used for one-to-one communication and multicast communication between the dockee 115 and peripheral devices of the WDN1 100, that is, the wireless display 102, the wireless camera 104, and the speaker 106. Likewise, a WTK2 is generated for communication in the WDN2 120. The WTK2 may be used for one-to-one communication and multicast communication between the dockee 115 and peripheral devices of the WDN2 120, that is, the wireless printer 122, the mouse 124, and the keyboard 126. That is, in the embodiment illustrated in FIG. 2, if the dockee 115 is group-connected with the WDN1 100, the dockee 115 obtains the WTK1 to communicate with the peripheral devices of the WDN1 100 and uses the WTK1 for communication in the WDN1 100. Similarly, if the dockee 115 is group-connected with the WDN2 120, the dockee 115 obtains the WTK2 to communicate with the peripheral devices of the WDN2 120 and uses the WTK2 for communication in the WDN2 120.

The WTK according to an embodiment of the present disclosure is defined as an effective temporary key in a corresponding WDN range for a predetermined effective time. The effective time of the WTK may be determined by a value of a WDN_Transient_Key_lifetime parameter. In each WDN, the effective time of the WTK may be set to a unique value. A main input value for generating the WTK according to an embodiment of the present disclosure may include an identifier (ID) of the WDN, a WDN-dedicated nonce value, and a MAC address of the docking center.

According to an embodiment of the present disclosure, the input value of the WTK may be determined based on an interface supported by the WDC. It is assumed that the WDC supports a plurality of physical interfaces. Herein, an interface is a Wi-Fi connection interface and may be identified by a MAC address. In this case, a plurality of WDNs may be connected with different physical interfaces, respectively. According to another embodiment of the present disclosure, the WDC may support a plurality of virtual interfaces as physical interfaces. In this case, each virtual interface may be connected with each WDN. According to another embodiment of the present disclosure, if the WDC supports a single interface, all the WDNs are connected to the single interface. As the input value for generating the WTK according to an embodiment of an interface supported by the WDC, a virtual MAC address connected to the WDC, a physical MAC address separately connected with the WDN, or a single MAC address of the WDC may be used.

Since the WDN ID and the WDN-dedicated nonce are used for generation of a WDN Master Key (WMK), the uniqueness of the WTK according to an embodiment of the present disclosure is maintained. According to an embodiment of the present disclosure, the effectiveness of the WMK may be determined by the WDN_Master_key_lifetime parameter. If the effectiveness of the WMK expires, the WMK is re-generated and WTKs based on the WMK are also re-generated.

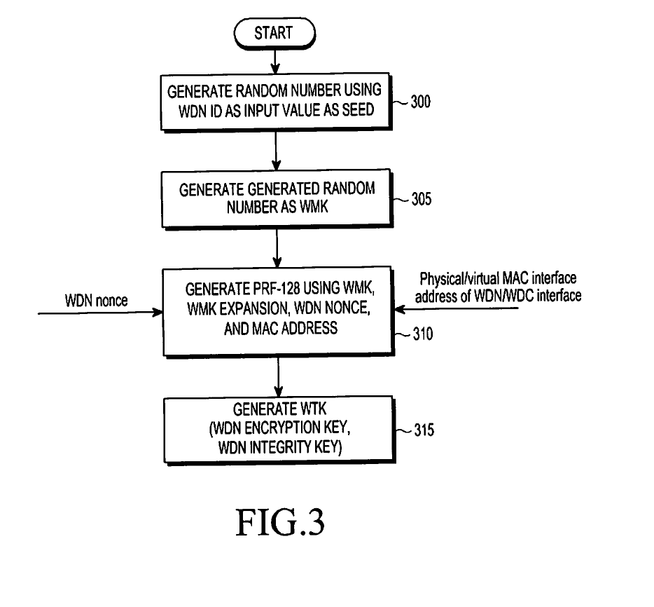

FIG. 3 is a flowchart illustrating a process of generating a WTK according to an embodiment of the present disclosure.

Referring to FIG. 3, in operation 300, a WDC inputs a WDN ID as an input value of a SHA-256 algorithm to generate a random number SHA-256 as a seed of a WMK. In operation 305, the WDC generates the generated random number as a 256-bit WMK (WMK<-SHA-256(WDN id).

In operation 310, the WDC generates PRF-128 by using a pseudo random function that generates a 128-bit result. Herein, an input value used in the function may include a WMK, a text “WMK Expansion”, a WDN MAC address, and a WDN nonce. The WDN nonce is a random number (or a pseudo random number) and is defined as a numeral or character string newly generated upon every WTK generation. Herein, the WDN MAC address may be a virtual MAC address or a physical MAC address of the WDN or the WDC according to an embodiment of the present disclosure. As a result, in operation 315, the WDC generates a WTK including a WDN encryption key and a WDN integrity key by using the PRF-128.

Once the WTK for the corresponding WDN is generated as described above, the WTK according to an embodiment of the present disclosure is distributed for use between the dockee, the docking center, and the peripheral devices of the WDN. WTK distribution schemes may include an in-band distribution scheme and an out-of-band distribution scheme according to an embodiment of the present disclosure.

* In-Band Distribution Scheme

First, when the WTK is distributed using the in-band distribution scheme, two embodiments may be described. That is, the in-band distribution scheme may be described using an embodiment in which a 2-way WTK handshake message is used and an embodiment in which a 4-way handshake message is used. However, it should be noted that the in-band distribution scheme according to an embodiment of the present disclosure is merely described using the foregoing two embodiments and is not limited to the embodiments described herein.

1. In-band distribution using a 2-way WTK handshake message:

In an embodiment of the present disclosure, a new 2-way WTK handshake message for WTK distribution is defined as described below. Herein, a handshake is generally performed after a 4-way handshake message used for delivering a PTK to devices.

The 2-way handshake may be formed with 2 EAP over LAN (EAPOL) (defined in the IEEE 802.1x)-key frame messages exchanged between a WDN owner and a WDN client, for example, based on an Extensible Authentication Protocol (EAP) that is an authentication protocol extensible between a user and an authenticator in the standard IEEE 802.1x that defines an authentication mechanism among a user, an authenticator, and an authentication server.

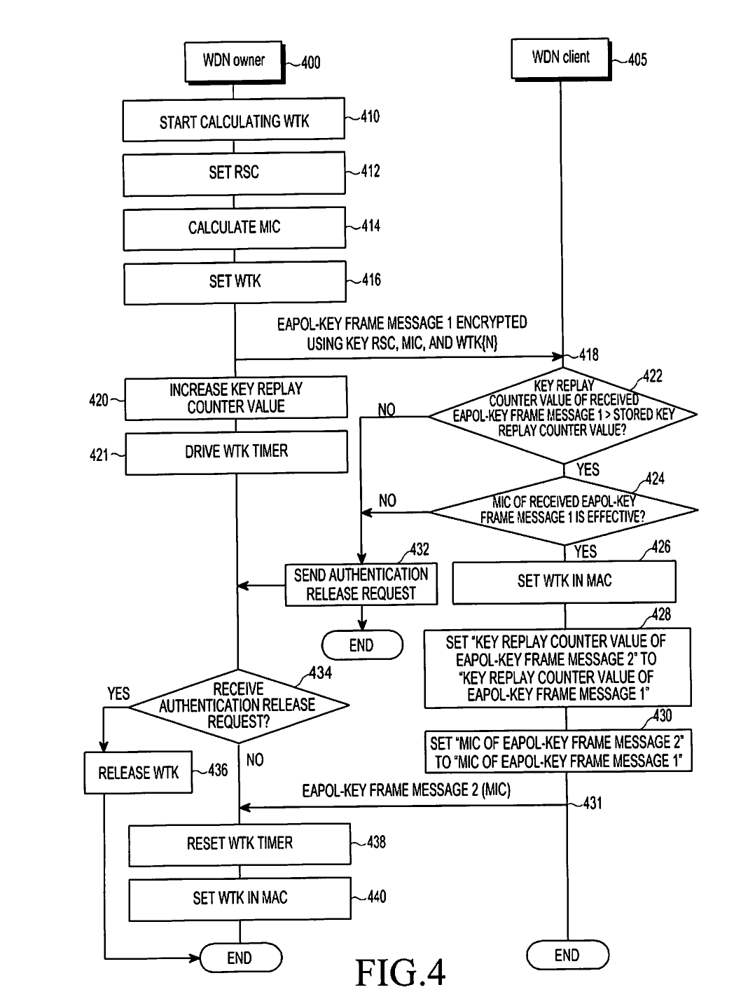

FIG. 4 is a flowchart illustrating a process of an in-band distribution scheme using a 2-way WTK handshake message according to an embodiment of the present disclosure. A WDC according to an embodiment of the present disclosure may use multiple WDNs as described above, and operates as an owner of a WDN. A dockee and peripheral devices of the WDN are defined as WDN clients. For convenience, in FIG. 4, operations between an owner of a particular WDN, a WDN owner, and a WDN client corresponding to a dockee or peripheral devices of the WDN will be described.

The first message of a handshake according to an embodiment of the present disclosure, that is, an EAPOL-key frame message 1 may include a key RSC, an MIC, and a WTK encrypted with a Key Encryption Key (KEK) of a PTK. Herein, the KEK is defined for data encryption in an EAPOL-key frame. Thus, referring to FIG. 4, in operation 410, a WDN owner 400 starts WTK calculation according to an embodiment of the present disclosure. Herein, the WTK is assumed to be calculated in a manner described with reference to FIG. 3. In operation 412, the WDN owner 400 sets a sequence number of the last frame transmitted using the calculated WTK to a Receive Sequence Counter (RSC). In operation 414, the WDN owner 400 calculates a Message Integrity Check (MIC) by using a Key Confirmation Key (KCK) obtained from a PTK in a body of an EAPOL-key frame. Herein, the KEK is defined as a key used for integrity check in the EAPOL key frame. The MIC is processed as ‘0’ for calculation. In operation 416, the WDN owner 400 sets the WTK using the KEK of the PTK. In operation 418, the WDN owner 400 sends the EAPOL-key frame message 1 including the key RSC, the MIC, and the WTK, which is obtained in operations 410 to 416, to a WDN client 405. In operation 420, after sending the EAPOL-key frame message 1, the WDN owner 400 increases a key replay counter value.

The WDN client 405 having received the EAPOL-key frame message 1 goes to operation 422. In operation 422, the WDN client 405 determines whether the key replay counter value of the EAPOL-key frame message is greater than a stored key replay counter value. That is, the key replay counter value of the EAPOL-key frame message should be greater than a key replay counter value of a previous EAPOL-key frame message received through a current session.

In operation 424, the WDN client 405 determines whether the MIC of the received EAPOL-key frame message 1 is effective. That is, the WDN client 405 determines using the KCK, which is a part of the PTK obtained in a WDN group connection procedure, whether there is no problem in data integrity. If determining that the MIC is effective, the WDN client 405 sets the WTK in an IEEE 802.11 MAC, in operation 426.

In operation 428, a key replay counter of a message #2 of 4. WTK handshake, that is, the EAPOL-key frame 2 to a key replay counter of the EAPOL-key frame 1. In operation 430, an MIC of the EAPOL-key frame message 2 is calculated using the KCK in the body of the EAPOL-key frame 1. In operation 431, the EAPOL-key frame message 2 is sent to the WDN owner 400. The EAPOL-key frame message 2 includes the MIC and the key replay counter that are set in operations 428 and 430.

If determining that the key replay counter value of the received EAPOL-key frame message 1 is less than or equal to the stored key replay counter value in operation 422, the WDN client 405 goes to operation 432. Likewise, if determining that the MIC of the received EAPOL-key frame message 1 is not effective in operation 424, the WDN client 405 goes to operation 432. In operation 432, the WDN client 405 sends an authentication release request to the WDN owner 400.

Upon recognizing reception of the authentication release request in operation 434, the WDN owner 400 goes to operation 436 to release the WTK set in the WDN client 405. If the EAPOL-key frame message 2 is received in response to the EAPOL-key frame message 1 in operation 432 without receiving a disconnection request after transmitting the EAPOL-key frame message 1, the WDN owner 400 determines whether the key replay counter value of the EAPOL-key frame message 2 is identical to the key replay counter value set in the EAPOL-key frame message 1. The WDN owner 400 also checks the effectiveness of the MIC of the EAPOL-key frame message 2 by using the KCK that is a part of the PTK. If determining that the key replay counter value of the EAPOL-key frame message 2 is identical to the set key replay counter value and the MIC is effective, the WDN owner 400 resets in operation 438 the WTK counter that is set after transmission of the EAPOL-key frame message 1 in operation 421. In operation 440, like in operation 426, the WTK is set in the MAC.

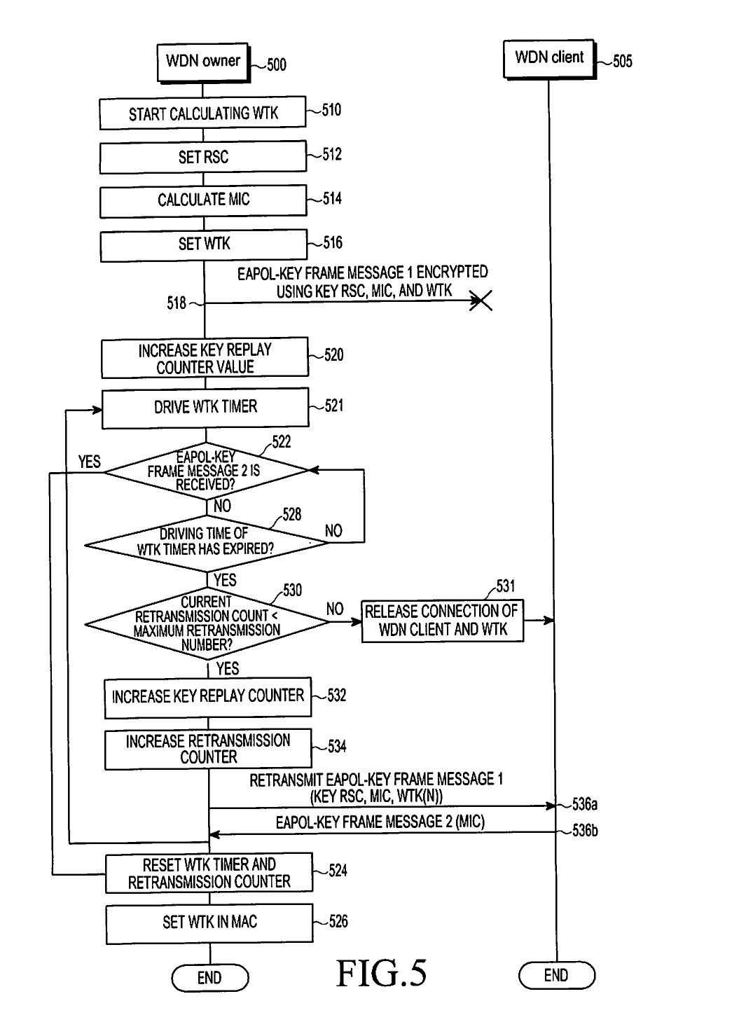

FIG. 5 is a flowchart illustrating a WTK retransmission operation in a 2-way WTK handshake scheme according to an embodiment of the present disclosures.

Referring to FIG. 5, a process in which a WDN owner 500 encrypts an EAPOL-key frame message 1 by using the WTK and sends the encrypted EAPOL-key frame message 1 to a WDN client 505 in operations 510 to 518 is the same as operations 410 to 418 of FIG. 4. However, it is assumed that the EAPOL-key frame message 1 in operation 518 is not successfully received by the WDN client 505.

In operation 520, the WDN owner 500 sets a retransmission counter to ‘0’ upon initial transmission of the EAPOL-key frame message 1. In operation 521, the WDN owner 500 drives a WTK timer. In operation 522, the WDN owner 500 determines whether a response to transmission of the EAPOL-key frame message 1, that is, an EAPOL-key frame message 2 has been received from the WDN client 505. If the EAPOL-key frame message 2 has been received, the WDN owner 500 resets the WTK timer and the retransmission counter in operation 524 and sets the WTK to a MAC in operation 526.

If the EAPOL-key frame message 1 has not been received in operation 522, the WDN owner 500 determines whether a driving time of the WTK timer has expired in operation 528. If the driving time of the WTK timer has not expired, the WDN owner 500 waits for expiration of the driving time.

If determining that the driving time of the WTK timer has expired, the WDN owner 500 compares a current retransmission count with a preset maximum retransmission number WTK retransmission limit. If the current retransmission count is less than the maximum retransmission number WTK_retransmission_limit, the WDN owner 500 increases the key replay counter and the retransmission counter by 1 in operations 532 and 534, respectively. In operation 536a, the WDN owner 500 retransmits the EAPOL-key frame message 1 to the WDN client 505. It is assumed that a response to the retransmitted EAPOL-key frame message 1 is received from the WDN client 505 in operation 536b. In this case, the WDN owner 500 goes to operations 524 and 526 to prepare for communication using the WTK.

According to an embodiment of the present disclosure, the driving time of the WTK timer may be set, for example, to 100 ms for first retransmission of the EAPOL-key frame message 1, to a half of a listen interval for second retransmission, and to the listen interval for subsequent retransmission. If the listen interval does not exist, the driving time may be set to the same value, for example, ‘100 ms’, regardless of the number of retransmissions.

If determining that the current retransmission count is equal to or greater than the maximum retransmission number WTK_retransmission_limit in operation 530, the WDN owner 500 releases the WTK and delivers an authentication release request to the WDN client 505 in operation 531.

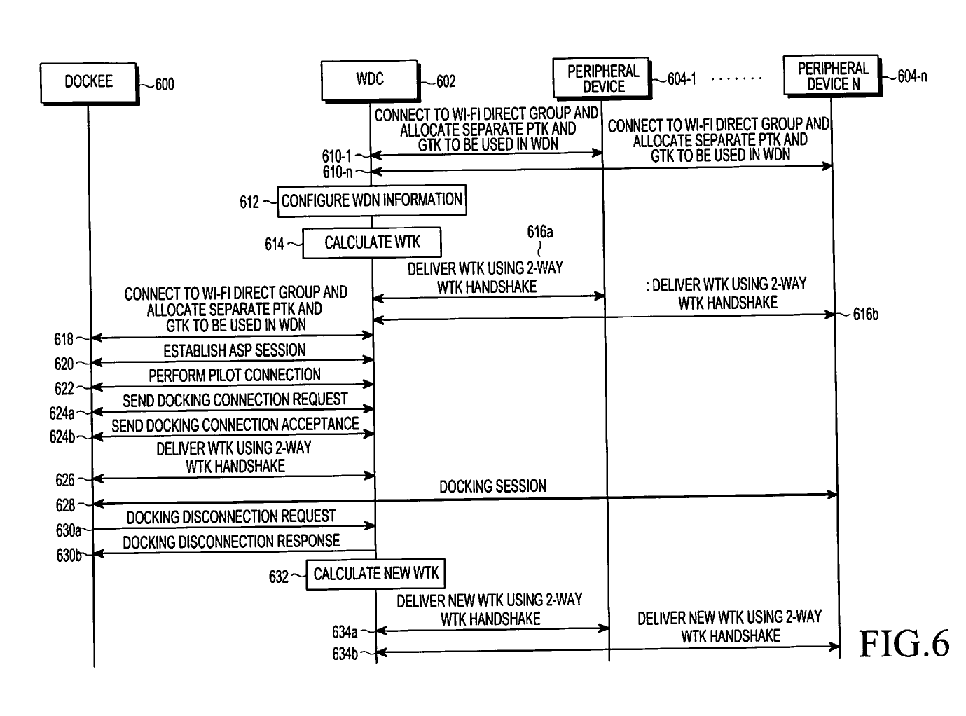

FIG. 6 is a ladder diagram illustrating a process of distributing a WTK based on a WTK 2-way handshake in a docking scenario according to an embodiment of the present disclosure. Herein, it is assumed that peripheral devices providing a service in a dockee 600, for example, a peripheral device 1 604-1 through a peripheral device n 604-n are connected to a WDC 602.

Referring to FIG. 6, it is assumed that the peripheral devices 1 604-1 through n 604-n among peripheral devices connected to a WDC 602 perform a joining (connection) procedure for a Wi-Fi Direct group whose WDN owner, that is, Group Owner (GO) is the WDC 602, respectively, through operations 610-1 through 610-n. In a Wi-Fi Direct group connection process, each of the peripheral devices 1 604-1 through n 604-n receives a PTK and a GTK for the Wi-Fi Direct group from the WDC 602. Although not shown in FIG. 6, some necessary peripheral devices among the peripheral devices connected to the WDC 602 are grouped for a particular WDN and WDN setup is finished. In operation 612, the WDC 602 maps for management, information about peripheral devices for each generated WDN and WDN information such as a PTK and a GTK assigned for each WDN, to the corresponding WDN.

As such, once generation of the WDN information is completed, the WDC 602 generates the WTK as described with reference to FIG. 3 in operation 614. Then, a WDC 720 according to an embodiment of the present disclosure performs the 2-way WTK handshake scheme to distribute the generated WTK to the peripheral device 1 604-1 and the peripheral device 2 604-n in operations 616a and 616b, respectively. Once the 2-way handshake is completed, the peripheral device 1 604-1 and the peripheral device 2 604-n may communicate through the WTK. The 2-way handshake in operations 616a and 616b is the same as that described in FIG. 4 and thus will not be described in detail.

The dockee 600 may recognize services provided by the WDC 602 using pre-association discovery. Assuming that a desired service exists among the services, the dockee 600 performs a group connection procedure with the WDC 602 to obtain information about a service and a peripheral device provided by the WDN in operation 618. During the group connection procedure, the dockee 600 receives a PTK and a GTK for the WDN. Once the group joining procedure is completed, the dockee 600 and the WDC 602 establish an Application Service Platform (ASP) session for establishing a connection and docking session in operation 620 and perform pilot connection for transmitting and receiving docking messages with the WDC 602 in operation 622. The dockee 600 may obtain additional information from the WDC 602 through the pilot connection. In operation 624a, the dockee 600 delivers a docking connection request to the WDC 602 based on the additional information. In operation 624b, the WDC 602 sends an acceptance of the docking connection request to the dockee 600 as a response. Once completing this operation, the dockee 600 is connected with the WDC 602 and thus becomes a member of the WDN, that is, joins the WDN as a WDN client. Then, in operation 626, the WDC 602 performs the WTK 2-Way handshake procedure with the dockee 600 in the manner described in FIG. 4 and delivers the WTK generated in operation 614 to the dockee 600. Once completing the procedure, the dockee 600 may communicate with all peripheral devices in the WDN by using the WTK through a docking session in operation 628. Once completing the docking session, the dockee 600 sends a docking disconnection request from the WDC 602 in operation 630a. In operation 630b, the dockee 600 receives a response to the docking disconnection request. In this case, the WDC 602 generates a new WTK in operation 632 such that the dockee 600 cannot connect to the WDN again with the existing WTK generated in operation 614. In operations 634a and 634b, the WDC 602 distributes the new WTK to peripheral devices of the WDN, that is, the peripheral device 1 604-1 and the peripheral device 2 604-n, respectively.

2. In-band distribution using a 4-way handshake

The WTK may be distributed using a 4-way handshake procedure according to an embodiment of the present disclosure. The 4-way handshake procedure is used to generate and distribute a PTK and a GTK to devices of a Wi-Fi Direct group. The 4-way handshake procedure supports user-defined Key Data Encapsulation (KDE) distribution through a third EAPOL-key frame. The user-defined KDE may be used to distribute a WTK in place of a 2-way handshake according to an embodiment. The EAPOL-key frame has a variable-length key data item such that additional key information may be delivered during key exchange. The additional key information may include zero (0) or more KDE. The WTK may be encrypted through a KEK extracted from the PTK and thus may be included in the KDE of the EAPOL-key frame.

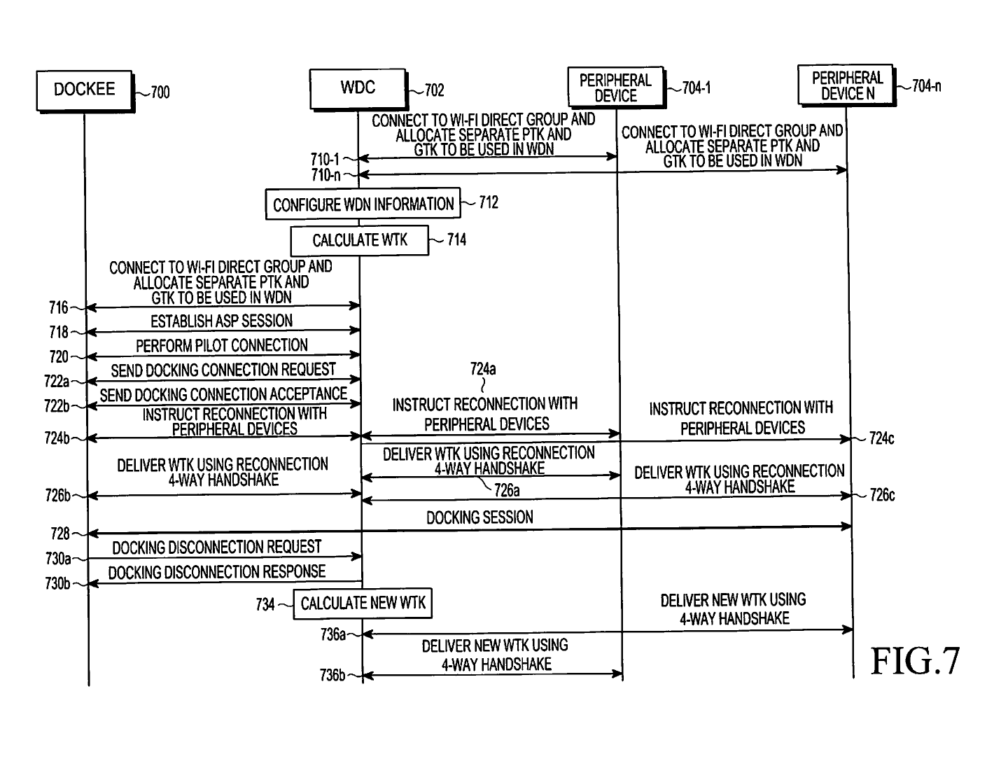

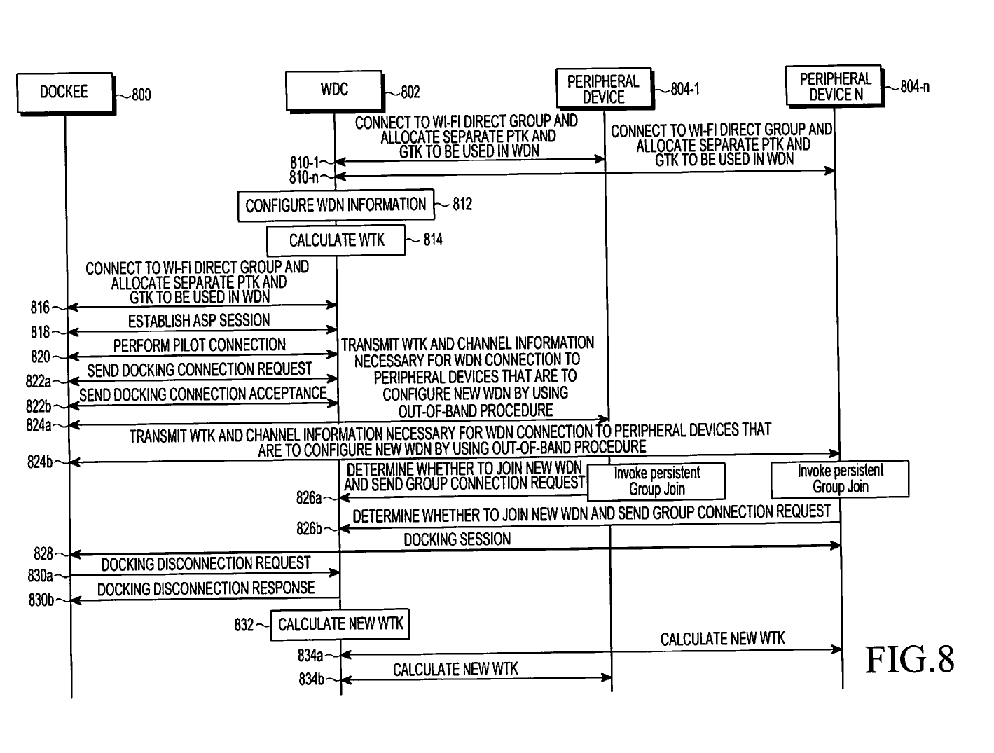

FIG. 7 is a ladder diagram illustrating operations of an in-band distribution scheme using a KDE procedure of a 4-way handshake according to another embodiment of the present disclosure. The WDN client and the WDN owner of FIG. 8 are defined in the same manner as those of FIG. 4.

Referring to FIG. 7, operations 710-1 through 722b are the same as operations 610-1 through 622b of FIG. 6. Through these operations, a dockee 700 is connected to a WDC 702 and thus joins a WDN as a WDN client of the WDN.

In operations 724a through 724c, the WDC 702 instructs re-connection with all peripheral devices connected to the WDC 702, that is, a peripheral device 1 704-1 through a peripheral device n 704-n, and with the dockee 700. Thus, in operations 726a through 726c, re-connection 4-way handshakes are performed, respectively. That is, the WTK is distributed to each peripheral device and the dockee 700 through the above-described KDE mechanism. Once the procedure is completed, a docking session is established and the dockee 700 may communicate with all peripheral devices in the WDN by using the WTK through the docking session in operation 728.

If the docking session is terminated, the dockee 700 sends a docking disconnection request to the WDN and receives a response to the docking disconnection request in operations 730a and 730b, respectively. To prevent the dockee 700 from being connected again to the WDN using the existing WTK generated in operation 714, the WDC 702 generates a new WTK in operation 734. In operations 736a and 736b, the WDC 702 instructs all peripheral devices of the WDN to perform re-connection and distributes the new WTK through the 4-way handshake.

* Out-of-Band Distribution Scheme

Next, the WTK may be distributed based on an out-of-band distribution scheme according to an embodiment of the present disclosure. The out-of-band distribution scheme may be, for example, a technique such as Near Field Communication (NFC).

FIG. 8 is a ladder diagram illustrating operations of an in-band distribution scheme using a KDE procedure of a 4-way handshake according to another embodiment of the present disclosure.

Referring to FIG. 8, in operations 810-1 through 814, a WDC 802 performs a Wi-Fi Direct group joining procedure with peripheral devices. In a Wi-Fi Direct group connection process, each of a peripheral device 1 804-1 through a peripheral device n 804-n receives a PTK and a GTK for the Wi-Fi Direct group from the WDC 802.

In operations 812 and 814, the WDC 802 configures WDN information and generates the WTK, like in operations 612 and 614 of FIG. 6. In operation 816, a dockee 800 performs the Wi-Fi Direct group joining procedure with the WDC 802 by using an out-of-band procedure such as NFC, and receives the PTK and the GTK for the Wi-Fi Direct group. Then, in operations 816 through 822b, a docking session is established with the WDC 802. Operations 816 through 822b are performed in the same manner as in operations 620 through 624b of FIG. 6.

In operations 824a and 824b, the dockee 800 delivers the WTK and channel information necessary for WDN connection to peripheral devices, that is, the peripheral device 1 804-1 and the peripheral device n 804-n. Herein, the channel information includes an operation channel, an Internet Protocol (IP) address, and the like. The dockee 800 may deliver the WTK, the IP address, and the channel information to each of the peripheral device 1 804-1 and the peripheral device n 804-n by using the out-of-band procedure such as an NFC handover/communication token. Upon completing operations 824a and 824b, the peripheral device 1 804-1 and the peripheral device 804-n may have information for proposing a persistent P2P group. Thus, in operations 826a and 826b, the peripheral device 1 804-1 and the peripheral device n 804-n perform persistent P2P group connection for joining a new WDN with the WDC 802 based on the channel information received through the foregoing procedure, respectively. Then, in operation 828, the docking session is established and thus the dockee 800 may communicate with the peripheral device 1 804-1 and the peripheral device n 804-n that complete group connection to the new WDN by using the WTK.

An effective time of the WTK according to an embodiment of the present disclosure is set based on the above-described WDN_Transient_key_lifetime. Thus, if the WTK calculated in operation 814 reaches the effective time, it loses effectiveness. Thus, in operations 830a and 830b, the dockee 800 sends a disconnection request for the new WDN to the WDC 802 and receives a response to the disconnection request from the WDC 802, respectively. Then, the WDC 802 generates a new WTK in operation 832, and delivers the new WTK to the peripheral devices in operations 834a and 834b, respectively.

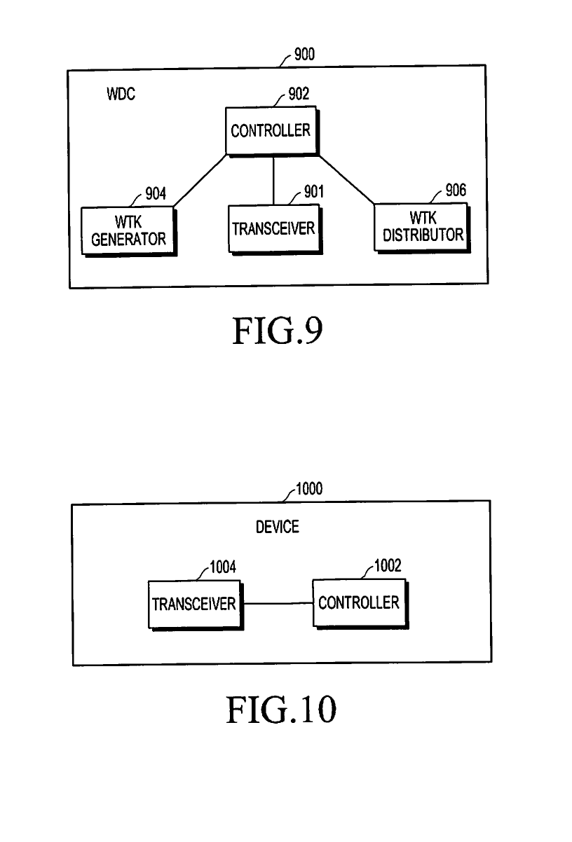

FIG. 9 is a block diagram of a WDC according to an embodiment of the present disclosure.

Referring to FIG. 9, a WDC 900 may include, for example, a transceiver 901, a controller 902, a WTK generator 904, and a WTK distributor 906. Although the WDC 900 is separately structured on the basis of operations according to an embodiment of the present disclosure for convenience, one unit may be divided into sub units for a separate unit according to an embodiment or an intention of an operator.

First, the controller 902 controls overall operation corresponding to a configuration and distribution of a WTK according to an embodiment of the present disclosure. The transceiver 901, the WTK generator 904, and the WTK distributor 906 may perform corresponding operations according to an instruction of the controller 902. The transceiver 901 transmits and receives messages or information with peripheral devices or a WDC based on an instruction of the controller 902 according to the above-described embodiments of FIGS. 4 through 8.

The WTK generator 904 generates a WTK for a WDN according to an instruction of the controller 902, for example, in the manner described in FIG. 3. The WTK according to an embodiment of the present disclosure may be generated separately for a WDN of a WDC configured on a service basis, and each WDN has a preset effective time, such that if the effective time has expired, a new WTK needs to be generated.

The WTK distributor 906 delivers the WTK to members of the WDN according to the above-described in-band and out-band schemes. Embodiments of the schemes have already been described with reference to FIGS. 4 to 8 and thus will not be described in detail.

FIG. 10 is a block diagram of a dockee or a peripheral device according to an embodiment of the present disclosure.

Referring to FIG. 10, a device 1000 may include a controller 1002 and a transceiver 1004. The device 1000 has been structured on the basis of operations according to an embodiment of the present disclosure for convenience, but one unit may be divided into sub units for a separate unit according to an embodiment or an intention of an operator.

The transceiver 1004 transmits and receives corresponding messages and information according to the above-described embodiments of FIGS. 4 to 8. Then, based on the messages and the information, the controller 1002 obtains a WTK transmitted from a WDC, determines effectiveness, delivers a response through the transceiver 1004 if the effectiveness of the WTK is obtained, or communicates with peripheral devices by using the WTK.

As is apparent from the foregoing description, the present disclosure defines a group key enabling the dockee to communicate with all peripheral devices in the WDN, defines a separate group key for each WDN if a plurality of WDNs exist in one Wi-Fi Direct group, and communicates based on the group key in the WDN, thereby improving communication security in the WDN. Moreover, it is possible to reduce a transmission delay caused by additional encryption and decryption performed by an existing dockee for communication with a peripheral device through a docking center due to the group key in the WDN.

While the present disclosure has been particularly shown and described with reference to exemplary embodiments thereof, various changes in form and detail may be made therein without departing from the spirit and scope of the present disclosure as defined by the following claims. Accordingly, the scope of the present disclosure will be defined by the appended claims and equivalents thereto.

What is claimed is:

1. A communication method using a group key for security of a wireless docking-based service, the communication method comprising:
grouping peripheral devices for each wireless docking-based service in association with the peripheral devices and generating a group key that is effective for a time being predetermined for each group; and
delivering the group key of the group to clients of the group.

2. The communication method of claim 1, wherein the group key generated for each group is set using an identifier of the group as an input value.

3. The communication method of claim 1, further comprising generating a new group key of the group and delivering the group key to clients of the group, if the effective time of the group key has expired.

4. The communication method of claim 1, further comprising delivering the group key through a group connection process for a dockee that has sent a request for connection to the group.

5. The communication method of claim 1, further comprising:
calculating a new group key of the group upon receiving a request for disconnection from the group from the dockee; and
delivering the new group key to clients of the group.

6. The communication method of claim 1, wherein the delivering of the group key comprises:
sending a request for disconnection to the clients comprising the dockee, if completing connection between the group and the dockee that has sent the request for connection to the group; and
delivering the group key to the clients comprising the dockee during the disconnection.

7. A communication method using a group key for security of a wireless docking-based service, the communication method comprising:
performing, with a docking center, a procedure for joining a group that supports a first service among wireless docking-based services provided by the docking center; and
obtaining group key-related information of the group from the docking center.

8. The communication method of claim 7, wherein the obtaining of the group key-related information comprises receiving security key-related information of the group, if sending a docking connection request to the docking center and receiving a response to the docking connection request after completing the group joining procedure.

9. The communication method of claim 7, wherein the obtaining of the group key-related information of the group comprises:
obtaining a group key of the group updated from the docking center that has performed re-connection with peripheral devices of the group, if sending the docking connection request to the docking center and receiving a response to the docking connection request after completing the group joining procedure; and
performing communication with the peripheral devices by using the updated group key of the group.

10. A docking center that communicates using a group key for security of a wireless docking-based service, the docking center comprising:
a controller configured to group peripheral devices for each wireless docking-based service in association with the peripheral devices and to generate a group key that is effective for a time being predetermined for each group; and
a transceiver configured to deliver the group key of the group to clients of the group according to an instruction of the controller.

11. The docking center of claim 10, wherein the group key generated for each group is set using an identifier of the group as an input value.

12. The docking center of claim 10, wherein if the effective time of the group key has expired, the controller controls the transceiver to generate a new group key of the group and to deliver the group key to clients of the group.

13. The docking center of claim 12, wherein the controller controls the transceiver to deliver the group key through a group connection process for a dockee that has sent a request for connection to the group.

14. The docking center of claim 10, wherein upon recognizing reception of a disconnection request from a dockee included in the group, the controller controls the transceiver to calculate a new group key of the group and to deliver the new group key to clients of the group.

15. The docking center of claim 10, wherein if connection between the group and the dockee that has sent the request for connection to the group is completed, the controller controls the transceiver to send a request for disconnection to the clients comprising the dockee and to deliver the group key to the clients comprising the dockee during the disconnection.

16. A communication device using a group key for security of a wireless docking-based service, the communication device comprising:
a controller configured to perform, with a docking center, a procedure for joining a group that supports a first service among wireless docking-based services provided by the docking center; and
a transceiver configured to obtain group key-related information of the group from the docking center.

17. The communication device of claim 16, wherein if sending a docking connection request to the docking center and receiving a response to the docking connection request after completing the group joining procedure, the transceiver receives security key-related information of the group.

18. The communication device of claim 17, wherein after completing the group joining procedure, if sending the docking connection request to the docking center and receiving a response to the docking connection request through the transceiver, and recognizing that a group key of the group updated from the docking center that has performed re-connection with peripheral devices of the group is obtained, then the controller performs communication with the peripheral devices by using the updated group key of the group.
